(19) United States
(12) Patent Application Publication
(10) Pub. No.: US 2009/0046464 A1
(43) Pub. Date: Feb. 19, 2009

(54) LED LAMP WITH A HEAT SINK

(75) Inventors: YI-SAN LIU, Shenzhen (CN); LI HE, Shenzhen (CN); TSUNG-LUNG LEE, Tu-Cheng (TW); XU-HUA XIAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 11/839,476

(22) Filed: Aug. 15, 2007

(51) Int. Cl. F21V 29/00; F21V 1/00

(52) U.S. Cl. 362/294; 362/373

(57) ABSTRACT

An LED lamp includes a heat sink (200), an LED module (100), and a lampshade (300). The heat sink (200) includes a hollow body (230) having an upper potion (235) and a bottom portion (238), a plurality of fins (240) extending from an outer periphery of the upper potion (235) of the body (230). The LED module includes a plurality of printed circuit boards (120) each mounted with six LEDs (110) thereon. The printed circuit boards (120) are mounted on the bottom portion (238) of the body (230). The lampshade (300) is secured to the heat sink (200) and encloses the LED module (100) and the bottom portion (238) of the body (230) of the heat sink (200).

### BACKGROUND OF THE INVENTION

1. Field of the Invention

The present invention relates to an LED lamp, and particularly to an LED lamp applying a heat sink for heat dissipation.

2. Description of Related Art

The technology of light emitting diode (LED) has been rapidly developed in recent years from indicators to illumination applications. With the features of long-term reliability, environment friendliness and low power consumption, the LED is viewed as a promising alternative for future lighting products. Nevertheless, the rate of heat generation increases with the illumination intensity. This issue has become a challenge for engineers to design the LED illumination, i.e. the LED lamp.

What is needed, therefore, is an LED lamp which has greater heat-transfer and heat dissipation capabilities, whereby the LED lamp can operate normally for a sufficiently long period of time.

### SUMMARY OF THE INVENTION

An LED lamp includes a heat sink, an LED module, and a lampshade. The heat sink includes a hollow body having an upper potion and a bottom portion, a plurality of fins extending from an outer periphery of the upper potion of the body. The LED module includes a plurality of LEDs mounted on an outer periphery of the bottom portion of the body. The lampshade is fixed to the heat sink at a position between the upper portion and the bottom portion of the body of the heat sink. The lampshade forms a housing for receiving the LED module and the bottom portion of the body therein. A plurality of heat pipes is attached to an inner face of the hollow body of the heat sink and extends from the bottom portion to the upper portion of the body of the heat sink.

### BRIEF DESCRIPTION OF THE DRAWINGS

Many aspects of the present LED lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views.

FIG. 1 is an isometric view of an LED lamp in accordance with a preferred embodiment of the present invention;

FIG. 2 is an exploded, isometric view of FIG. 1;

FIG. 3 is a partially assembled view of FIG. 2, with a lampshade and a transparent plate of the LED lamp of FIG. 2 being removed away; and

FIG. 4 is a cross-sectional view of FIG. 3.

### DETAILED DESCRIPTION OF THE INVENTION

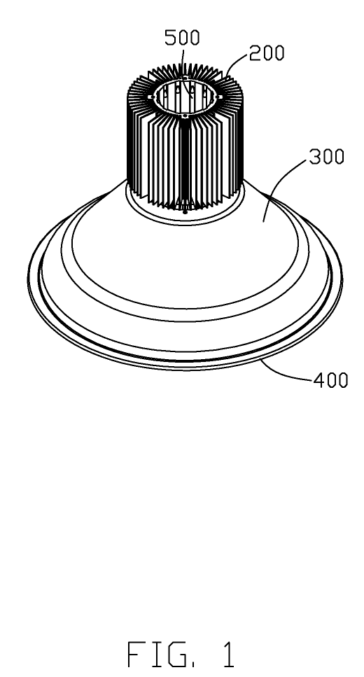

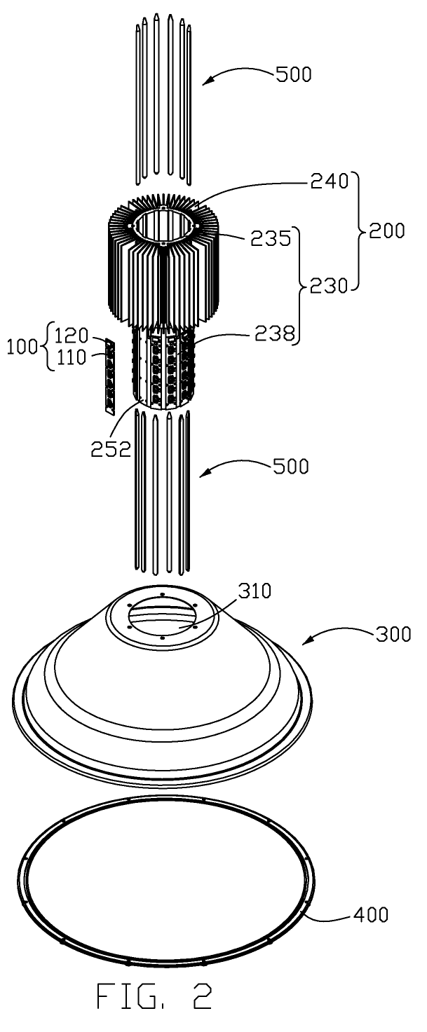

Referring to FIGS. 1-2, an LED (light emitting diode) lamp (not labeled) of a preferred embodiment of the invention comprises an LED module 100, a heat sink 200 for supporting and cooling the LED module 100, a plurality of heat pipes 500 engaged in the heat sink 200, a lampshade 300 mounted on a middle portion of the heat sink 200 and a transparent plate 400 mounted on a bottom portion of the lampshade 300.

The heat sink 200 made by aluminum extrusion, comprises a hollow and cylindrical heat conducting body 230 and a plurality of fins 240. The body 230 comprises an upper portion 235 and a bottom portion 238.

The lampshade 300 is a bowl-shaped, having a concave surface facing downwardly and a hole 310 defined in a central portion of the lampshade 300. The hole 310 is provided for the bottom portion 238 of the hollow body 230 to extend therethrough. The lampshade 300 is used to reflect the light emitted from the LED module 100 towards a desired downward direction.

The transparent plate 400 is generally made of plastic, glass, or other suitable material availing to transmit light and prevent foreign articles from entering the lamp to contaminate the LED module 100. The transparent plate 400 is engaged with a bottom of the lampshade 300 to thereby form an enclosed housing (not labeled) accommodating the LED module 100 therein, whereby the LED module 100 can have a sufficient protection from damage caused by an unintentional force acting on the LED lamp. Alternatively, the transparent plate 400 may be omitted, only having the lampshade 300 enclosing the LED module 100.

The LED module 100 is mounted on an outer periphery of the bottom portion 238 of the body 230 to form a three-dimensional light source to increase illumination effect of the LED lamp. The LED module 100 generally comprises a plurality of LEDs 110 mounted on a plurality of printed circuit boards 120. The LEDs 110 are installed into corresponding printed circuit boards 120 and electrically connected to the circuits (not shown) provide on the printed circuit boards 120. The printed circuit boards 120 are further electrically connected to a power (not shown) through wires (not shown) extending though the heat sink 200 or other mechanisms. The LEDs 110 and the printed circuit boards 120 are so arranged that six LEDs, which are arranged in a column are mounted on one of the printed circuit boards 120, which has an elongated configuration.

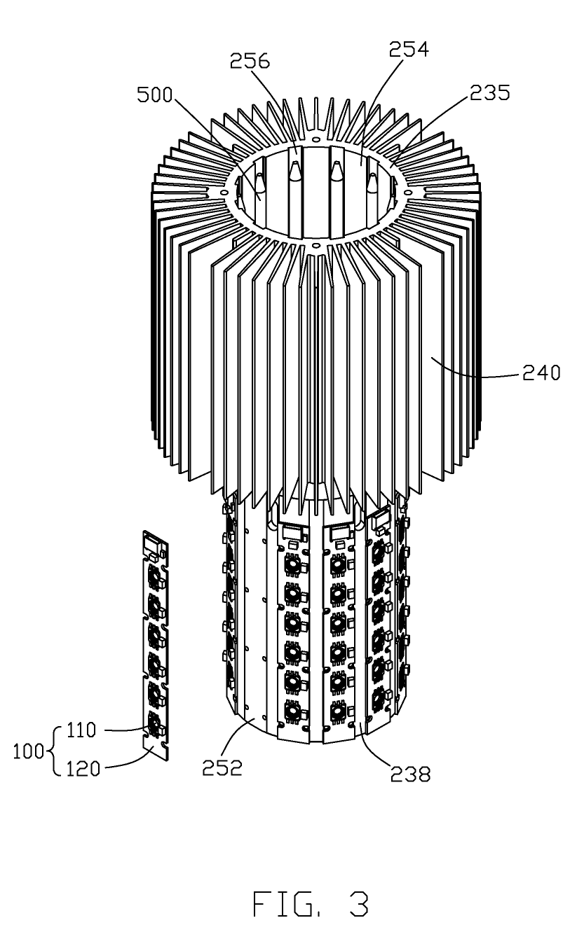

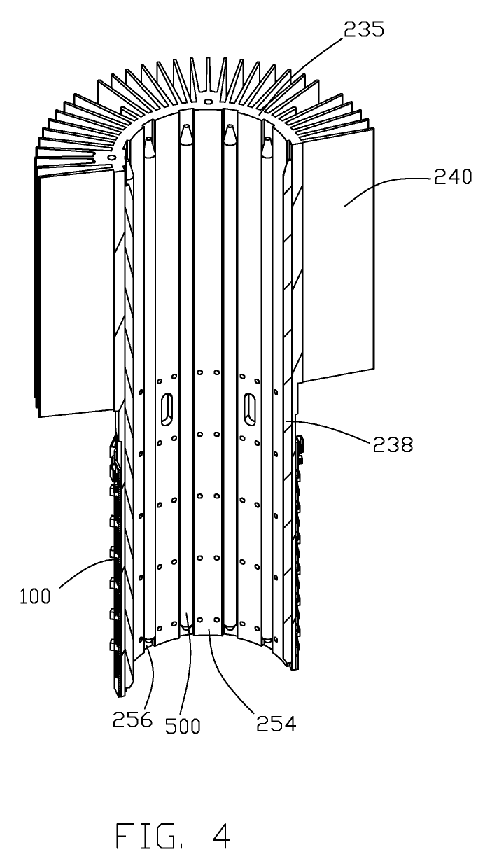

Referring also to FIGS. 3-4, the upper portion 235 of the body 230 has four connecting ribs (not labeled) evenly extending from an outer periphery along an axial direction thereof. Each rib has a top defining a fixing hole therein for allowing a fixing member to secure with the upper portion 235 and connect with a lamp holder (not shown), which is a standard component and available in the market. The fins 240 radially extend from the outer periphery of the upper portion 235 of the body 230. Each rib has three fins 240 extending therefrom. Each of the fins 240 extends along the axial direction of the upper portion 235. A plurality of short fins 240, shorter than other fins along a radial direction of the upper portion 235, are evenly arranged among the fins 240. A plurality of air passages is defined between adjacent fins 240 for airflow to flow therethrough. The lampshade 300 and the transparent plate 400 are positioned under the fins 240.

The bottom portion 238 of the body 230 is dodecagonal and has twelve side surfaces 252 at the outer periphery thereof. On each side surface 252 of the bottom portion 238 of the body 230, there is a printed circuit board 120 attached thereon, wherein the printed circuit board 120 is mounted with six LEDs 110 arranged in a line along the axial direction of the body 230.

The body 230 has a cylindrical inner surface 254. Twelve channels 256 provided to receive and retain the heat pipes 500 therein are symmetrically defined in the inner surface 254 and extend along the axial direction of the body 230. The channels 256 extend over the bottom portion 238 and the upper portion 235. Each channel 256 is corresponding to a respective one of the side surfaces 252 of the bottom portion 238. Thus, each channel 256 has a lower portion (not labeled) which is directly below the LEDs 110 mounted on the corresponding side surface 252. Furthermore, each heat pipe 500 has a lower, evaporating portion (not labeled) which is directly below the LEDs 110 mounted on the corresponding side surface 252, and an upper, condensing portion (not labeled) which is adjacent to the fins 240.

The heat pipes 500, each being I-shaped in profile, are retained in corresponding channels 256 of the body 230 and the heat pipes 500 connect with the upper portion 235 and the bottom portion 238 of the body 230. Therefore, heat produced by the LEDs 110 can be quickly and uniformly transferred to the heat sink 200. In other words, part of the heat produced by the LEDs 110 is transferred upwardly to the upper portion 235 of the body 230 of the heat sink 200 via the bottom portion 238 of body 230. Another part of the heat produced by the LEDs 110 is transferred upwardly to the upper portion 235 of the body 230 via the heat pipes 500. The heat, which has reached the upper portion 235 of the body 230, is then dissipated away to ambient air via the fins 240. Thus, the heat of the LEDs 110 can be quickly dissipated via the heat sink 200.

The heat sink 200 and the heat pipes 500 may be connected together via welding or other method. Then, the lampshade 300 with the transparent plate 400 is secured to the heat sink 200 at a position between the upper portion 235 and the bottom portion 238 of the body 230 to enclose the LED module 100 and the bottom portion 238 of the body 230 therein.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a heat sink comprising a hollow body having an upper potion and a bottom portion, a plurality of fins extending from an outer periphery of the upper potion of the body;
an LED module comprising a plurality of LEDs mounted on the bottom portion of the body, the LED module being supported and cooled by the heat sink; and
a lampshade secured to the heat sink at a position between the bottom portion and the upper portion of the body of the heat sink and enclosing the LED module and the bottom portion of the body.

2. The LED lamp as described in claim 1, wherein the fins radially and outwardly extend from the outer periphery of the upper potion of the body.

3. The LED lamp as described in claim 2, wherein each of the fins extends along an axial direction of the upper portion of the body.

4. The LED lamp as described in claim 1, further comprising a plurality of heat pipes thermally engaging with the body.

5. The LED lamp as described in claim 4, wherein the heat pipes extend over the upper portion and the bottom portion of the body.

6. The LED lamp as described in claim 4, wherein the body defines a plurality of channels in an inner surface thereof, and the heat pipes are arranged in the channels of the body.

7. The LED lamp as described in claim 6, wherein the bottom portion of the body has a dodecagonal cross section and twelve side surfaces, and the LEDs of the LED module are mounted on the side surfaces and surround the bottom portion of the body.

8. The LED lamp as described in claim 7, wherein the side surfaces of the bottom portion of the body each correspond to one of the heat pipes.

9. The LED lamp as described in claim 1, wherein the heat sink is made by aluminum extrusion.

10. The LED lamp as described in claim 1 further comprising a transparent plate secured to a free end the lampshade, the transparent plate and the lampshade together forming a housing receiving the LED module and the bottom portion of the body therein.

11. An LED lamp comprising:
a heat sink comprising hollow body having an upper portion and a bottom portion, and a plurality of fins attached to the upper portion;
a plurality of heat pipes thermally engaging in an inner surface of the body and extending over the bottom portion and the upper portion of the body; and
an LED module comprising a plurality of LEDs mounted on a periphery of the bottom portion of the body of the heat sink.

12. The LED lamp as described in claim 1, further comprising a lampshade engaging with the heat sink wherein the lampshade receives the bottom portion of the body of the heat sink and the LED module therein.

13. The LED lamp as described in claim 12, further comprising a transparent plate mounted on the lampshade, the transparent plate and the lampshade together forming a housing, the LED module and the bottom portion of the body of the heat sink being received in the housing.

14. The LED lamp as described in claim 11, wherein the heat sink is made of aluminum extrusion.

15. An LED lamp comprising:
a heat sink comprising a hollow body having an upper portion and a bottom portion, and a plurality of fins extending from the upper portion of the body of the heat sink;
an LED module having a plurality of elongated printed circuit boards mounted on an outer periphery of the bottom portion of the body of the heat sink and a plurality of LEDs mounted on the printed circuit boards; and
a lampshade mounted to the heat sink at a position between the upper portion and the bottom portion of the body of the heat sink, the lampshade enclosing the LED module and the bottom portion of the body of the heat sink.

16. The LED lamp as described in claim 15, wherein the bottom portion of the body of the heat sink has a polygonal configuration with a plurality of side surfaces formed on the outer periphery of the bottom portion of the body of the heat sink, the elongated printed circuit boards being attached to the side surfaces, respectively, and extending along an axial direction of the body of the heat sink.
